(19) United States
(12) Patent Application Publication
(10) Pub. No.: US 2020/0410474 A1
(43) Pub. Date: Dec. 31, 2020

(54) PROCESSING ACCOUNT TRANSFER REQUESTS

(71) Applicant: Advanced New Technologies Co., Ltd., George Town (KY)

(72) Inventors: Yun Xia, Hangzhou (CN); Zunfu Dai, Hangzhou (CN); Fan Yang, Hangzhou (CN)

(21) Appl. No.: 16/877,235

(22) Filed: May 18, 2020

Related U.S. Application Data
(63) Continuation-in-part of application No. PCT/CN2020/070892, filed on Jan. 8, 2020.

(30) Foreign Application Priority Data
May 29, 2019 (CN) 201910455717.8

(51) Int. Cl. G06Q 20/32; G06F 16/24

(52) U.S. Cl. CPC G06Q 20/3263; G06Q 20/3255; G06F 16/24

(57) ABSTRACT

This disclosure relates to account transfer request processing. In one aspect, a method includes obtaining an account transfer request submitted by a first terminal. The account transfer request is a request to transfer a transfer amount from the account of the initiator to a payee. Payee information corresponding to the payee of the account transfer request is obtained. The payee information includes identification information specifying payee contact information for the payee. A determination is made that the payee is not a registered user of a platform that initiated the account transfer request. This determination includes querying whether the identification information exists in a registered user database of the platform. In response to determining that the payee is not a registered user of the platform, a payment prompt that is configured to prompt the payee to collect payment of the account transfer is transmitted to a second terminal of the payee.

### CROSS-REFERENCE TO RELATED APPLICATIONS

This application is a continuation-in-part of PCT Application No. PCT/CN2020/070892, filed on Jan. 8, 2020, which claims priority to Chinese Patent Application No. 201910455717.8, filed on May 29, 2019, and each application is hereby incorporated by reference in its entirety.

### TECHNICAL FIELD

The present application relates to the field of computer technologies, and in particular, to account transfer request processing.

### BACKGROUND

Due to the limitations on some Internet financial platforms, when a user transfers money, the user cannot complete an operation of transferring money from the user to the payee if the payee is not a registered user of the platform. In addition, the user cannot even notify the payee that a payment is pending collection.

### SUMMARY

In view of this, implementations of the present application provide account transfer request processing methods, devices and equipment, so a registered user of a platform can transfer money to a payee who is not a registered user of the platform without relying on a third-party platform, thereby improving user experience.

To alleviate the previous technical problem, the implementations of the present specification are implemented as described below.

An implementation of the present specification provides an account transfer request processing method, including: obtaining an account transfer request submitted by a first terminal, where an account of an initiator of the account transfer request is logged into the first terminal; obtaining payee information corresponding to the account transfer request, where the payee information includes at least identification information specifying payee contact information; determining, based on the payee information, whether the payee is a registered user of a platform that initiates the account transfer request, to obtain a first determining result; and when the first determining result indicates that the payee is not a registered user, sending payment collection prompt information based on the identification information, so as to remind the payee to collect payment.

An implementation of the present specification provides an account transfer request processing device, including: an account transfer request acquisition module, configured to obtain an account transfer request submitted by a first terminal, where an account of an initiator of the account transfer request is logged into the first terminal; a payee information acquisition module, configured to obtain payee information corresponding to the account transfer request, where the payee information includes at least identification information specifying payee contact information; a first result determining module, configured to determine, based on the payee information, whether the payee is a registered user of a platform that initiates the account transfer request, to obtain a first determining result; and a payment collection prompt information sending module, configured to: when the first determining result indicates that the payee is not a registered user, send payment collection prompt information based on the identification information, so as to remind the payee to collect payment.

An implementation of the present specification provides an account transfer request processing equipment, including: at least one processor; and a memory communicatively connected to the at least one processor; where the memory stores instructions that can be executed by the at least one processor, and the instructions are executed by the at least one processor, to enable the at least one processor to: obtain an account transfer request submitted by a first terminal, where an account of an initiator of the account transfer request is logged into the first terminal; obtain payee information corresponding to the account transfer request, where the payee information includes at least identification information specifying payee contact information; determine, based on the payee information, whether the payee is a registered user of a platform that initiates the account transfer request, to obtain a first determining result; and when the first determining result indicates that the payee is not a registered user, send payment collection prompt information based on the identification information, so as to remind the payee to collect payment.

The at least one technical solution used in the implementations of the present application can achieve the following beneficial effects:

In the implementations of the present specification, by using the contact information as the identification information of the user, when the payee is not a registered user of the platform, the payment collection prompt information is sent to prompt the non-registered user to collect payment. In the implementations of the present specification, a register user of the platform can transfer money to a payee who is not currently a registered user of the platform without relying on a third-party platform, thereby improving user experience.

### BRIEF DESCRIPTION OF DRAWINGS

The accompanying drawings described here are intended to provide a further understanding of the present application, and constitute a part of the present application. The illustrative implementations of the present application and descriptions thereof are intended to describe the present application, and do not constitute limitations on the present application. In the accompanying drawings:

FIG. 1 is a schematic flowchart illustrating an account transfer request processing method, according to an implementation of the present specification;

FIG. 2 is a schematic interface diagram of sending registration information that includes identification information to an initiator for determining;

FIG. 3 is a schematic flowchart illustrating another account transfer request processing method, according to an implementation of the present specification;

FIG. 4 is a schematic structural diagram illustrating an account transfer request processing device corresponding to FIG. 1, according to an implementation of the present specification; and

FIG. 5 is a schematic structural diagram illustrating an account transfer request processing equipment corresponding to FIG. 1, according to an implementation of the present specification.

### DESCRIPTION OF IMPLEMENTATIONS

To make the objectives, technical solutions, and advantages of the present application clearer, the following clearly and comprehensively describes the technical solutions of the present application with reference to specific implementations and accompanying drawings of the present application. Clearly, the described implementations are merely some rather than all of the implementations of the present application. All other implementations obtained by a person of ordinary skill in the art based on the implementations of the present application without creative efforts shall fall within the protection scope of the present application.

The technical solutions provided in the implementations of the present application are described in detail below with reference to the accompanying drawings.

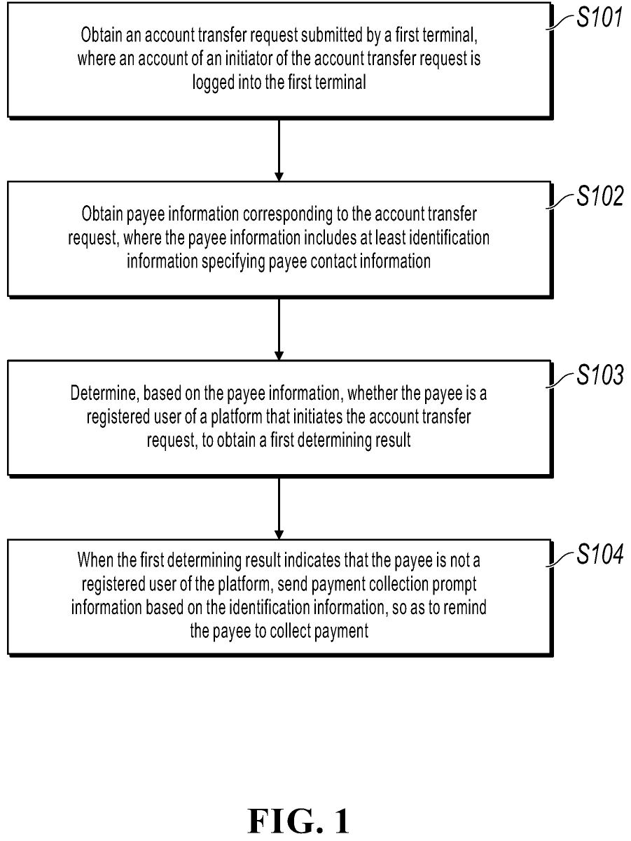

FIG. 1 is a schematic flowchart illustrating an account transfer request processing method, according to an implementation of the present specification. From a program perspective, the process can be executed by a program or an application client that is loaded on an application server.

As shown in FIG. 1, the process can include the following steps:

Step S101: Obtain an account transfer request submitted by a first terminal, where an account of an initiator of the account transfer request is logged into the first terminal.

In the implementation of the present specification, the account of the initiator of the account transfer request is logged into the first terminal, and the first terminal can be a mobile phone, a tablet computer, a smart watch, etc.

In the implementation of the present specification, the initiator is a registered user of the platform. When the initiator needs to perform a money transfer operation, the initiator logs in to a platform account by using the first terminal. The account transfer request can include payee information, a transfer amount, etc. The payee information can be an account name on the platform, or can be identification information such as a name and contact information. After obtaining the account transfer request of the initiator, the first terminal sends the account transfer request to a server.

In the implementation of the present specification, the “first” and “second” are merely used to distinguish a user from a terminal to prevent conceptual confusion, and are not of practical significance.

Step S102: Obtain payee information corresponding to the account transfer request, where the payee information includes at least identification information specifying payee contact information.

In the implementation of the present specification, contact information in the payee information can be used to represent payee identity information. The contact information can be any information by which the payee can be contacted, and can be a mobile phone number, an email address, or an account of another instant messaging APP. The identification information is used to refer to the contact information of the payee. The identification information can be an abbreviation of the contact information, or can directly refer to a mobile phone number or an email address, which is not specifically limited here.

In the implementation of the present specification, in addition to the contact information, the payee information can include other identity information, which can be a name, identity card information, passport information, etc.

Step S103: Determine, based on the payee information, whether the payee is a registered user of a platform that initiates the account transfer request, to obtain a first determining result.

In this implementation of the present specification, whether the payee is a registered user of the platform can be directly determined based on the payee information, or can be directly determined based on the contact information, or can be comprehensively determined with reference to other information in the payee information.

In the implementation of the present specification, a platform server can store registered user information. The platform server can directly determine whether the payee is a registered user based on the contact information, or can determine whether the payee is a registered user based on the contact information and other identity information. For example, the name and the contact information are used as combination to determine whether the payee is a registered user.

Step S104: When the first determining result indicates that the payee is not a registered user of the platform, send payment collection prompt information based on the identification information, so as to remind the payee to collect payment.

In the implementation of the present specification, if the payee is a registered user of the platform, transfer can be directly performed. If the payee is not a registered user of the platform, the payment collection prompt information can be sent to prompt the payee to collect payment. Since the account transfer request includes the contact information of the payee, such as the mobile phone number, the server can send the payment collection prompt information to a terminal corresponding to the mobile phone number. The payment collection prompt information can include information about how to perform user registration on the platform. After registering successfully, the payee can collect payment successfully.

In some financial platform transfer scenarios, when a registered user of the platform transfers money to a payee who is not a registered user of the platform, some third-party platforms are used to assist the transfer processing. In common banking system, an initiator can complete transfer by only providing a bank account of a payee. However, a bank account is not common information exchanged between users for communication, and a bank card number is personal privacy. Therefore, in some communication software, when a bank card number is entered, it is often considered as fraud information. Therefore, in an Internet financial service provider platform, the bank account should not be used as the transfer method considering security issues. In addition, the bank card number may be composed of 19 digits. It is inconvenient to remember and brings great inconvenience to the transfer.

In the implementation of the present specification, contact information is used as identification information of a user, for example, a mobile phone number or an email address. The mobile phone number and the email address are information usually exchanged between persons during daily communication. For example, contact information such as a telephone number or an email address is usually printed on a business card, and the previous contact information can be directly obtained from the business card during transfer. In addition, the telephone number or the email address is often used during communication. Therefore, using the contact information as the identification information of the user is an effective method that meets the daily habit of the user.

In addition, there can be multiple types of contact information in the registration information of the user on the platform, for example, a mobile phone number and an email address. That is, the user can bind both the email address and the mobile phone number, and multiple mobile phone numbers or email addresses can be bound. However, each piece of contact information can correspond to only one user, that is, two users do not have the same contact information. Based on a one-to-one correspondence between a user and contact information, the platform server can query the user based on the contact information.

In the method in FIG. 1, by using the contact information as the identification information of the user, when the payee is not a registered user of the platform, the payment collection prompt information is sent to prompt the non-registered user to collect payment. In the implementation of the present specification, a register user of the platform can transfer money to a payee who is not currently a register user of the platform without relying on a third-party platform. In addition, the contact information is used as the identification information, which is easy to operate and helps protect privacy of the user and improve user experience.

Based on the method in FIG. 1, an implementation of the present specification further provides some specific implementations of the method, which are described below.

Optionally, after the account transfer request submitted by the first terminal is obtained, the server can further identify and confirm the account of the initiator, and check whether the account of the initiator is in a normal state. If the account of the initiator is frozen, the account transfer request will not be executed.

Optionally, determining, based on the payee information, whether the payee is a registered user of the platform that initiates the account transfer request can specifically include: querying whether the identification information exists in a registered user database.

In the implementation of the present specification, when a user performs platform registration, in addition to filling in some common information such as a name, the user generally needs to fill in contact information (such as a mobile phone number or an email address). The server can store the registration information in the registered user database. Certainly, in addition to the registered user database, the user database can be another database, which is not specifically limited here. Therefore, when it is determined whether the payee is a registered user of the platform, the registered user database can be queried to determine whether the identification information corresponding to the contact information exists, which can be performed in a one-to-one way. If the registered user database includes the identification information, it indicates that the user of the contact information corresponding to the identification information is a registered user of the platform. Assume that the contact information is 2389xxx@ xxx.com, when it is found that the registered user database does not include “2389xxx@ xxx. com”, it indicates that the payee corresponding to 2389xxx@xxx.com is not a registered user. When “2389xxx@xxx.com” is included in the registered user database, it indicates that the payee corresponding to 2389xxx@xxx.com is a registered user.

In the implementation of the present specification, there can be multiple types of contact information in the registration information of the user on the platform, for example, a mobile phone number and an email address. That is, the user can bind both the email address and the mobile phone number, and multiple mobile phone numbers or email addresses can be bound. However, each piece of contact information can correspond to only one user, that is, two users do not have the same contact information. Based on a one-to-one correspondence between a user and contact information, the platform server can query the user based on the contact information. For example, contact information of Alice in registration information on the platform may be: “123xxxx4567, 2389xxx@xxx.com”.

The contact information is different from an identity card number. The identity card number is fixed after a person is born, and the contact information changes with time. For example, a user of the mobile phone number “123xxxx4567” in 2000 is “Alice”, while a user of the mobile phone number in 2018 may be “Bob”. Therefore, sometimes an error may occur if only the contact information in the payee information is queried in the registered user database to determine whether the payee is a registered user of the platform. Therefore, in some implementations of this implementation of the present specification, to improve accuracy of determining a registered user, during querying, in addition to the identification information, other information such as a name of the payee can be included. The name and the contact information can be used together for comparison. Only when the name and the contact information are corresponding to the same user, the user can be determined as a registered user. If the name and the contact information are corresponding to different users, it cannot be determined that the user corresponding to the contact information is a registered user. For example, the payee information in the account transfer request includes Alice and 130xxxx1234. During the query of the registered user database, the name of the account name corresponding to “130xxxx1234” is Bob. Clearly, the information of the payee is inconsistent. Therefore, the payee in the account transfer request cannot be determined as a registered user.

Optionally, sending payment collection prompt information based on the identification information can specifically include: generating the payment collection prompt information based on the account transfer request, where the payment collection prompt information includes at least the identification information; and when the contact information is a mobile phone number, sending the payment collection prompt information to a terminal corresponding to the mobile phone number, and prompting the payee to use the mobile phone number as the contact information for user registration.

In the implementation of the present specification, sending methods for the payment collection prompt information are provided for two different pieces of contact information. When the contact information is a mobile phone number, the payment collection prompt information needs to be sent to a terminal corresponding to the mobile phone number. The payment collection prompt information is transmitted by using a communications base station, and is finally transmitted to the terminal corresponding to the mobile phone number.

Specifically, the payment collection prompt information can be generated based on the account transfer request, and can include transfer initiator information and transfer amount information. The payment collection prompt information can further include: steps for performing platform registration, and a download address or a webpage registration address of an APP corresponding to the platform. For example, “Hello, user of the mobile phone number 130xxxx1234. Alice transfers 500 Yuan to your account. Please log in to the following website for downloading XX software and register using “130xxxx1234”. In addition, the way of downloading XX software is not limited to a website, and a two-dimensional code for downloading the software can be directly provided.

In some specific implementations, to improve security, the payment collection prompt information can further include an authorization code. The authorization code is used by the payee to fill in during the registration. The authorization code can be a string of numbers and/or letters, or can be in another authorization form such as a barcode or a two-dimensional code.

In some specific implementations, to improve security, the payment collection prompt information can further include a registration time limit. The time limit can be used to limit the user registration time. It can be expressed in the form of “Please register before 20:00 on Mar. 15, 2019”. The time limit can also be a limitation on a valid time range of the authorization code, and can be expressed in the form of “The authorization code is valid before 20:00 on Mar. 15, 2019”. When registration is performed beyond the valid time range, the transfer cannot be completed successfully. Transfer can fail in multiple cases: One is that registration fails; the other is that the registration can be successfully completed, but the payment collection cannot be successfully performed. In the second case, the initiator needs to resubmit the account transfer request.

In the implementation of the present specification, user registration can be performed by the payee only by using the mobile phone number as the contact information, so the server can determine whether a newly registered user is the payee corresponding to the contact information. Assume that the contact information is a mobile phone number, while the contact information filled in by the payee during registration is an email address. In this case, the server cannot detect a registered user whose mobile phone number is the contact information in the registered user database, and the server determines that the payee has not registered, which causes that the account transfer request cannot be completed.

Optionally, sending the payment collection prompt information to a terminal corresponding to the mobile phone number can specifically include: sending the payment collection prompt information to the terminal corresponding to the mobile phone number in a short message form; and/or sending the payment collection prompt information to the terminal corresponding to the mobile phone number in a voice form.

In some specific implementations, when the mobile phone number is used as the contact information, the payment collection prompt information can be sent by using a short message to the terminal corresponding to the mobile phone number, and a user of the mobile phone number performs user registration after discovering the short message received by the terminal. However, in many cases, the user cannot see the short message on the terminal in time when they are busy. In this case, to improve user experience, voice can be further used to prompt the user to register. In another better implementation, after the voice is used to prompt the user to perform registration, the voice can further be sent in a text form to the terminal of the mobile phone number. As such, the user is prompted in time, and registration is convenient for the user.

Optionally, sending payment collection prompt information based on the identification information can specifically include: generating the payment collection prompt information based on the account transfer request, where the payment collection prompt information includes at least the identification information; and when the contact information is an email address, sending the payment collection prompt information to the email address, and prompting the payee to use the email address as the contact information for user registration.

In the implementation of the present specification, an implementation of sending the payment collection prompt information by using an email address as the contact information is further provided. Compared with the mobile phone number being used as the contact information, a sending path of the payment collection prompt information is different. 1234567@xxx.com is used as an example. The payment collection prompt information is first sent to a server address of the xxx mailbox. When an account of 1234567@xxx.com has an operation of receiving email, the payment collection prompt information is sent to the email address 1234567@xxx.com.

Optionally, before the sending payment collection prompt information based on the identification information, the method can further include: determining a transfer amount in the account transfer request; deducting the transfer amount from the account of the initiator; and storing the transfer amount in a temporary account; and after the sending payment collection prompt information based on the identification information, the method can further include: obtaining registration information that includes the identification information; determining whether the registration information is consistent with the payee information, to obtain a second determining result; and when the second determining result indicates that the registration information is consistent with the payee information, transferring the transfer amount in the temporary account to a newly created account of the payee, where contact information in registration information of the newly created account of the payee is the same as the contact information corresponding to the identification information.

In the implementation of the present specification, to provide an opportunity for the initiator to improve the account transfer request, the server further sets a temporary account for storing the transfer amount. After receiving the account transfer request, the server first deducts the amount from the account of the initiator of the account transfer request, and then transfers it to the temporary account. The temporary account can be created by the server for the current account transfer request, one account transfer request corresponds to one temporary account, and if the account transfer request is completed, the temporary account is cancelled. The temporary account can also be an intermediate transition account, and all account transfer requests are corresponding to the same intermediate transition account. The intermediate transition account always exists and will not be cancelled with the completion of the account transfer request.

In the implementation of the present specification, after sending the payment collection prompt information to the payee, the server always detects whether a new user registers. Each time a new user registers, registration information is obtained. When registration information in which the contact information included in the payee information in the account transfer request is used is obtained, it is further determined whether the user is the payee corresponding to the account transfer request. The registration information can be compared with the payee information. If the registration information is consistent with the payee information, it indicates that the newly established account is the payee account. Then, the transfer amount in the temporary account is transferred to the account of the user corresponding to the payee. Being consistent here means that all content in the payee information exists in the registration information and is the same.

Optionally, the registration information can include a name and contact information; or a name, contact information, and certificate information. The certificate information can be an identity card, a passport, a driver's license, an officer's certificate, etc., which is not specifically limited here.

In this implementation of the present specification, there is also a scenario that user A initiates transfer to a user whose mobile phone number is “135xxxx1234”. If a transfer platform server learns through querying that a user registered with this mobile phone number does not exist in the registered user database, the transfer platform server sends a short message or voice notification to the mobile phone number “135xxx1234” to prompt the user to register. After receiving the short message or voice, user B finds that user B has registered with the transfer platform by using an email address or other contact information. In this case, user B can log in to the transfer platform, add the mobile phone number to the contact information of user B. After the mobile phone number is added, the transfer platform learns, based on a second determining result, that the user corresponding to the mobile phone number already exists (or registered), and can perform a subsequent transfer operation.

In some specific implementations, to improve security and accuracy of the transfer, the payee information can further include other identity information of the user, such as a name, a native place, and identity card information. When a user registers on a platform involving financial transfer, the user usually needs to undergo real-name authentication or fill in other information. Then, when the registration information is compared with the payee information, the name and the contact information can be compared at the same time. Only when the name and the contact information are the same, the registration information and the payee information can be determined as consistent. For example, the payee information is Alice, 130xxxx1234, and the registration information of user B is Alice, male, identity card number 2201561975xxxx1123, and telephone number 130xxxx1234. Because the registration information includes “Alice, 130xxxx1234”, user B can be determined as the payee corresponding to the account transfer request. In this case, the transfer amount in the temporary account can be transferred to the account of user B.

In some specific implementations, to improve transfer security, a transfer amount transferred to a newly created account of a payee can be frozen for a period of time, which can be 5 hours or 24 hours, and the time can be set based on actual requirements. The payee cannot perform any operation on the transfer amount during this period, and the initiator can select, upon request, whether to withdraw the transfer amount.

In this implementation of the present specification, the transfer service is split into two phases of fund flow processing, and the user transfer service is completed in combination with the user registration service.

Optionally, when the second determining result indicates that the registration information is inconsistent with the payee information, the transfer amount in the temporary account is transferred to the account of the initiator.

In the previous implementation, when the registration information is consistent with the payee information, the transfer amount is transferred to the account of the payee. In another case, when the registration information is inconsistent with the payee information, it indicates that the payee fails to register, and the account transfer request cannot be completed. Therefore, the transfer amount in the temporary account needs to be returned to the account of the initiator.

In the implementation of the present specification, there are multiple methods for determining whether the registration information is consistent with the payee information. Whether the registration information is consistent with the payee information can be automatically determined by the server based on setting criteria, or can be determined together with the initiator of the account transfer request.

Optionally, determining whether the registration information is consistent with the payee information can specifically include: sending the registration information to the first terminal, and prompting the initiator to confirm the registration information; obtaining confirmation information that is sent by the first terminal and that is of the initiator for the registration information; and determining, based on the confirmation information, whether the registration information is consistent with the payee information.

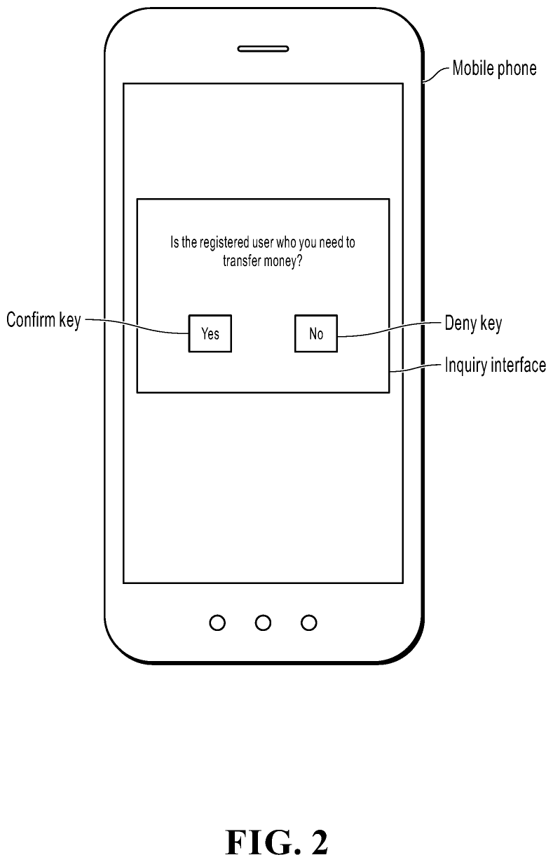

In some specific implementations, to improve security, the registration information can be sent to the initiator for determining in the present disclosure. The registration information sent to the initiator can include a name and contact information of the registered user, and can further include some certificate information. The initiator can be consulted in the form of an inquiry. FIG. 2 is a schematic interface diagram of sending registration information that includes identification information to an initiator for determining. As shown in FIG. 2, there is an inquiry interface on the mobile phone. The inquiry interface includes two parts: an upper part, which is an inquiry area; and a lower part, which is a user confirmation area. The inquiry area displays “Is the registered user who you need to transfer?”. The confirmation area contains two options: Yes and No. If the registered user is a user who the initiator needs to be transfer, the initiator clicks Yes. If the registered user is not a user who the initiator needs to be transfer, the initiator clicks “No”. After receiving the feedback from the initiator, the server first determines whether the feedback information of the initiator is Yes or No. If the feedback information of the initiator is Yes, the user corresponding to the registration information in the present specification is the payee of the account transfer request. If the feedback information of the initiator is No, the user corresponding to the registration information in the present specification is not the payee of the account transfer request.

In some specific implementations, the server can perform some screening first, filter out some registration information that clearly is not suitable, and send only information that satisfies a predetermined rule to the sender for confirmation, thereby omitting some steps and avoiding a waste of time.

Optionally, determining whether the registration information is consistent with the payee information can specifically include: obtaining first user identity information included in the payee information, where the first user identity information includes at least a name; obtaining second user identity information included in the registration information; and determining whether the first user identity information is consistent with the second user identity information.

In some specific implementations, the server sets some matching rules to automatically identify whether the registration information is consistent with the payee information. If the contact information in the registration information is consistent with the payee information, other identity information of the user can be determined. For example, in addition to the contact information, the payee information can include a name, and the registration information of the user also includes information such as a name. Therefore, the name in the payee information can be compared with the name in the registration information. If the two names are the same, it indicates that the user corresponding to the registration information is the payee. As such, the user does not need to consider whether the payee is a registered user of the platform. The platform server automatically prompts the user to register, automatically determines the payee, and automatically completes transfer, so the user can transfer money smoothly, thereby improving user experience.

In addition, the first user identity information and the second user identity information can further include other information. The name is only used as an example here, but is not restrictive.

In the implementation of the present specification, the “first” and “second” are merely used to distinguish between different identity information to prevent conceptual confusion, and are not of practical significance.

Optionally, after the sending payment collection prompt information based on the identification information, the method can further include: determining whether the payee corresponding to the identification information is successfully registered within a predetermined time period, to obtain a third determining result; and when the third determining result indicates that the payee corresponding to the identification information is not successfully registered within the predetermined time period, returning the transfer amount in the temporary account to the account of the initiator.

In this implementation of the present specification, after the payment collection prompt information is sent, the payee may not receive the previous information, or the payee may not register in time for some reason. In this case, the server cannot always wait for the payee to register for the security of the transfer. Therefore, a time period needs to be predetermined. If the payee registers successfully within the time period, the account transfer request can be completed. If the payee fails to register successfully, the account transfer request will be cancelled. Then, the transfer amount in the temporary account is returned to the account of the initiator.

The predetermined time period can start from the time when the initiator initiates the account transfer request, or can start from the time when the payment collection prompt information is sent, provided that start time points are consistent.

In addition, duration of the predetermined time period can be set based on actual situations, and can be set to 12 hours, 24 hours, or 48 hours. In addition, the duration of the predetermined time period can also be modified based on time data registered by the user.

In one case, the predetermined time period is set too long. Assume that an initial value of the predetermined time period is 48 hours. If five registered users are monitored, and respectively 1 hour, 3 hours, 10 hours, 18 hours, and 23 hours are used for registration, it can be found that all the registration time of the five users is less than 24 hours. In this case, it can be deduced that in most normal cases, a user can successfully complete registration within 24 hours. Therefore, the predetermined time period can be modified from 48 hours to 24 hours.

In another case, the predetermined time period is set too short. Assume that the initial value of the predetermined time period is 12 hours. It is found that four of the five initiated account transfer requests are not completed, and the user registration time of a payee in another account transfer request is 11 hours. It can be deduced that this may be related to the short predetermined time period. In this case, the predetermined time period can be prolonged from 12 hours to 24 hours. Then user registration effects are observed, and real-time adjustment is performed based on obtained feedback information.

Optionally, after the storing the transfer amount in a temporary account, the method can further include: obtaining a refund request initiated by the initiator for the account transfer request; and when it is determined that the initiating time of the refund request does not exceed a time limit, returning the transfer amount to the account of the initiator.

In some specific implementations, after initiating the account transfer request, the initiator finds that the account transfer request is incorrectly filled in, for example, an incorrect transfer amount or incorrect payee information. In a word, to ensure that the transfer can be carried out based on the initiator's real intention, there can be a remedy. That is, after submitting the account transfer request, the initiator can revoke the request. The ultimate purpose of revoking the request is to prevent the transfer amount from entering the account of the payee.

Optionally, when it is determined that the initiating time of the refund request does not exceed a time limit, returning the transfer amount to the account of the initiator can specifically include: determining whether the transfer amount is stored in the temporary account to obtain a fourth determining result; if the fourth determining result indicates that the transfer amount is stored in the temporary account, returning the transfer amount in the temporary account to the account of the initiator; or if the fourth determining result indicates that the transfer amount is not stored in the temporary account, obtaining a completion time of the account transfer request; and when it is determined that the completion time does not exceed the first predetermined time, returning the transfer amount to the account of the initiator.

In this implementation of the present specification, the premise for initiating a refund request is that the transfer amount is not in the account of the initiator. Therefore, there are two cases for the refund request: One is that the transfer amount is in the temporary account, and the other is that the transfer amount is in the account of the payee.

For the first case, that is, the fourth determining result indicates that the transfer amount is stored in the temporary account, and the initiator can at any time request to return the transfer amount to the account of the initiator. In addition, there is also a limitation on the time that the transfer amount can exist in the temporary account. As mentioned in the previous implementation, “the payee corresponding to the identification information is not successfully registered within the predetermined time period, return the transfer amount in the temporary account to the account of the initiator”. Assume that the predetermined time period is 24 hours, that is, the transfer amount can exist in the temporary account for a maximum of 24 hours. If the transfer amount exists in the temporary account more than 24 hours, the transfer amount will be automatically returned to the account of the initiator. Therefore, the “time limit” in this implementation can be set to 24 hours, and the initiator can cancel the account transfer request at any time within 24 hours.

For the second case, that is, the fourth determining result indicates that the transfer amount is not stored in the temporary account, and the transfer amount is stored in an account other than the temporary account, i.e., in the account of the payee, there can be two processing methods:

1. Same as the processing for the case where the transfer amount is stored in the temporary account, the initiator can initiate a refund request within the predetermined time period. Assume that the predetermined time period is 24 hours, no matter what account the transfer amount is in, a refund can be requested within 24 hours.

2. Different from the previous method, in this case, the transfer completion time needs to be determined, that is, how long it takes to transfer the transfer amount to the payee account. The transfer amount is frozen for a period of time after the transfer amount is transferred to the payee account. That is, although the transfer amount is in the payee account, the transfer amount is not subject to the payee. Within this period of time, if a refund request is initiated, the transfer amount can be directly returned to the account of the initiator. However, after this period of time, the transfer amount cannot be returned to the account of the initiator.

The sum of the first predetermined time and the transfer completion time can be greater than the “predetermined time period” in the first case. In this case, the initiator can better protect his/her interests. For example, the transfer completion time is defined as a time starting from the moment when the account transfer request is initiated to the moment when the transfer amount is received by the payee and is 5 hours, the first predetermined time is set to 20 hours, and the total time length is 25 hours, which is higher than 24 hours of the “predetermined time period” in the first case.

The sum of the first predetermined time and the transfer completion time can be less than the “predetermined time period” in the first case. In this case, the account transfer request can be more quickly completed. For example, if the transfer completion time is 5 hours and the first predetermined time is set to 10 hours, the total time length is 15 hours and is less than 24 hours of the “predetermined time period” in the first case.

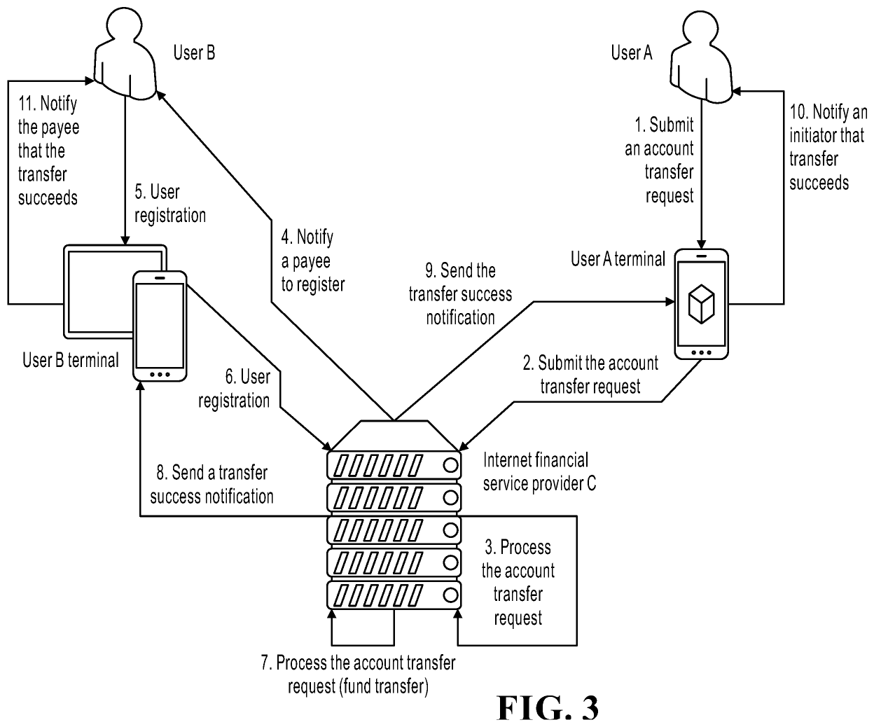

FIG. 3 is a schematic flowchart illustrating another account transfer request processing method, according to an implementation of the present specification. As shown in FIG. 3, this implementation of the present specification includes three devices: 1. User A terminal (or equipment); 2. User B terminal (or equipment); 3. Internet financial service provider C (server). User A is already a registered user of the Internet financial service provider, and user B is not a registered user of the Internet financial service provider.

The account transfer request processing method provided in this implementation of the present specification includes the following steps:

Step 1: User A enables the user terminal equipment, selects a transfer service, and fills in an amount and user B identity identification, where the identity identification is contact information, and the contact information can include a mobile phone number, an email address, etc. User A submits an account transfer request on its terminal.

Step 2: User A terminal equipment sends the account transfer request to Internet financial service provider C.

Step 3: Internet financial service provider C verifies identity information of user A and user B, creates a transfer service document, completes money deduction of user A, and transfers money from user A to an intermediate transition account.

Step 4: Internet financial service provider C prompts user B to collect payment by using identity identification of user B (phone number, short message, email).

Step 5: User B registers by using its equipment and the identity identification.

Step 6: The user B terminal sends user registration information to Internet financial service provider C, and user B becomes a registered user of Internet financial service provider C.

Step 7: Internet financial service provider C detects that user B completes user registration, automatically triggers payment collection processing, transfers money from the intermediate transition account to user B account, and completes the transfer service.

Step 8: Internet financial service provider C sends payment collection success information to the user B terminal.

Step 9: Internet financial service provider C sends transfer success information to the user A terminal.

Step 10: User B receives the transfer success information on its terminal.

Step 11: User A receives the transfer success information on its terminal.

In the method in FIG. 3, the contact information is used as identification information of user B. When user B is not a registered user of the platform, payment collection prompt information is sent to the contact information of user B, to prompt user B to collect the payment. User B registers based on the payment collection prompt information. After detecting that user B has registered successfully, Internet financial service provider C transfers money from the intermediate transition account to user B account to complete the transfer service. In the implementation of the present specification, without relying on a third-party platform, not only money transfer from a registered user of the platform to a payee who is not a registered user of the platform can be completed, but also contact information is used as identification information. Compared with bank card transfer, the operation is simple, user privacy is protected, and user experience is improved.

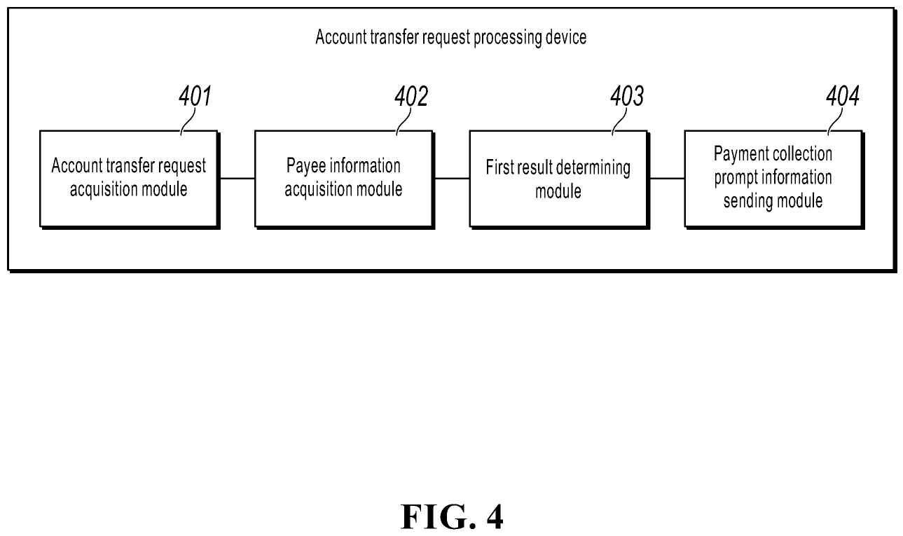

Based on the same idea, an implementation of the present specification further provides a device that corresponds to the previous method. FIG. 4 is a schematic structural diagram illustrating an account transfer request processing device corresponding to FIG. 1, according to an implementation of the present specification. As shown in FIG. 4, the device can include: an account transfer request acquisition module 401, configured to obtain an account transfer request submitted by a first terminal, where an account of an initiator of the account transfer request is logged into the first terminal; a payee information acquisition module 402, configured to obtain payee information corresponding to the account transfer request, where the payee information includes at least identification information specifying payee contact information; a first result determining module 403, configured to determine, based on the payee information, whether the payee is a registered user of a platform that initiates the account transfer request, to obtain a first determining result; and a payment collection prompt information sending module 404, configured to: when the first determining result indicates that the payee is not a registered user, send payment collection prompt information based on the identification information, so as to remind the payee to collect payment.

The device in FIG. 4 determines the payee information by using the account transfer request acquisition module 401 and the payee information acquisition module 402, and the first result determining module 403 determines, based on the payee information, whether the payee is a registered user. When the first result determining module 403 determines that the payee is not a registered user of the platform, the payment collection prompt information sending module 404 sends the payment collection prompt information to prompt the non-registered user to perform payment collection. In the implementation of the present specification, a registered user of the platform can transfer money to a payee who is not a registered user of the platform without relying on a third-party platform, and the contact information is used as the identification information. Compared with bank card transfer, the operation is simple, user privacy is protected, and user experience is improved.

Optionally, the first result determining module 403 can be specifically configured to query whether the identification information exists in a registered user database.

Optionally, the payment collection prompt information sending module 404 can specifically include: a first payment collection prompt information generation unit, configured to generate the payment collection prompt information based on the account transfer request, where the payment collection prompt information includes at least the identification information; and a first payment collection prompt information sending unit, configured to: when the contact information is a mobile phone number, send the payment collection prompt information to a terminal corresponding to the mobile phone number, and prompt the payee to use the mobile phone number as the contact information for user registration.

Optionally, the payment collection prompt information sending module 404 can specifically include: a second payment collection prompt information generation unit, configured to generate the payment collection prompt information based on the account transfer request, where the payment collection prompt information includes at least the identification information; and a second payment collection prompt information sending unit, configured to: when the contact information is an e-mail address, send the payment collection prompt information to the e-mail address, and prompt the payee to use the e-mail address as the contact information for user registration.

Optionally, the device can further include: a transfer amount determining module, configured to: before the payment collection prompt information is sent based on the identification information, determine a transfer amount in the account transfer request; a transfer amount deduction module, configured to deduct the transfer amount from the account of the initiator; a transfer amount storage module, configured to store the transfer amount in a temporary account; a registration information acquisition module, configured to: after the payment collection prompt information is sent based on the identification information, obtain registration information that includes the identification information; a second result determining module, configured to determine whether the registration information is consistent with the payee information, to obtain a second determining result; and a transfer amount transfer-in module, configured to: when the second determining result indicates that the registration information is consistent with the payee information, transfer the transfer amount in the temporary account to a newly created account of the payee, where contact information in registration information of the newly created account of the payee is the same as the contact information corresponding to the identification information.

Optionally, the second result determining module can specifically include: a first registration information sending unit, configured to send the registration information to the first terminal, and prompt the initiator to confirm the registration information; a confirmation information acquisition unit, configured to obtain confirmation information that is sent by the first terminal and that is of the initiator for the registration information; and a first determining unit, configured to determine, based on the confirmation information, whether the registration information is consistent with the payee information.

Optionally, the second result determining module can specifically include: a first user identity information acquisition unit, configured to obtain first user identity information included in the payee information, where the first user identity information includes at least a name; a second user identity information acquisition unit, configured to obtain second user identity information included in the registration information; and a second determining unit, configured to determine whether the first user identity information is consistent with the second user identity information.

Optionally, the device can further include: a first transfer amount returning module, configured to: when the second determining result indicates that the registration information is inconsistent with the payee information, return the transfer amount in the temporary account to the account of the initiator.

Optionally, the registration information can include a name and contact information; or a name, contact information, and certificate information.

Optionally, the device can further include: a third result determining module, configured to: after the payment collection prompt information is sent based on the identification information, determine whether the payee corresponding to the identification information is successfully registered within a predetermined time period, to obtain a third determining result; and a second transfer money returning module, configured to: when the third determining result indicates that the payee corresponding to the identification information is not successfully registered within the predetermined time period, return the transfer amount in the temporary account to the account of the initiator.

Optionally, the device can further include: a refund request acquisition module, configured to: after the transfer amount is stored in the temporary account, obtain a refund request initiated by the initiator for the account transfer request; and a transfer amount returning module, configured to: when it is determined that the initiating time of the refund request does not exceed a time limit, return the transfer amount to the account of the initiator.

Optionally, the first payment collection prompt information sending unit can specifically include: a first payment collection prompt information sending subunit, configured to send the payment collection prompt information to a terminal corresponding to the mobile phone number in a short message form; and a second payment collection prompt information sending subunit, configured to send the payment collection prompt information to the terminal corresponding to the mobile phone number in a voice form.

Based on the same idea, an implementation of the present specification further provides an equipment that corresponds to the previous method.

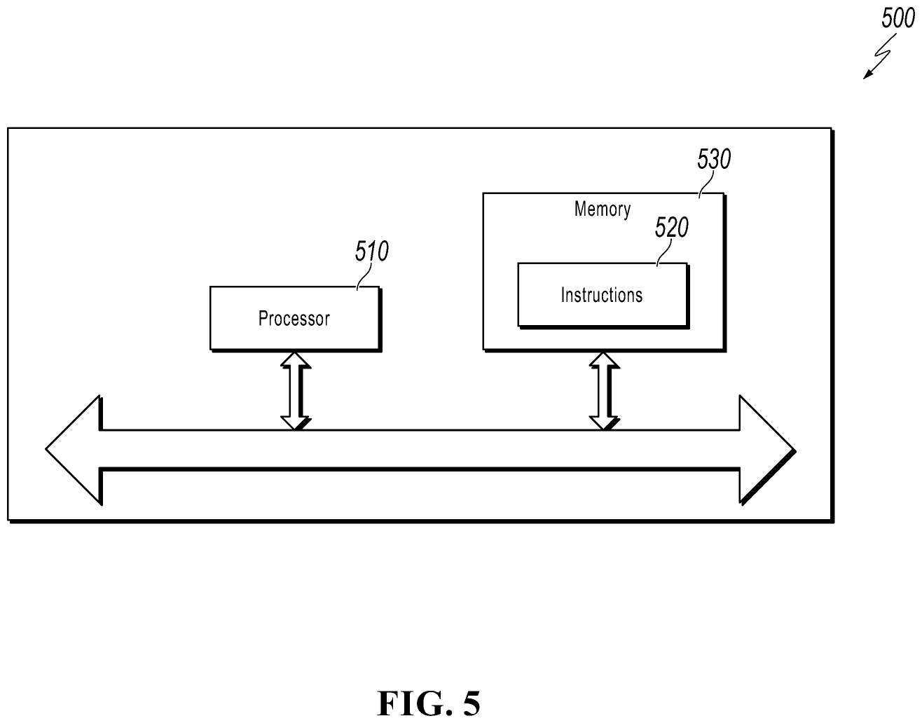

FIG. 5 is a schematic structural diagram illustrating an account transfer request processing equipment corresponding to FIG. 1, according to an implementation of the present specification. As shown in FIG. 5, the equipment 500 can include: at least one processor 510; and a memory 530 communicatively connected to the at least one processor; where the memory 530 stores instructions 520 that can be executed by the at least one processor 510, and the instructions are executed by the at least one processor 510, to enable the at least one processor 510 to: obtain an account transfer request submitted by a first terminal, where an account of an initiator of the account transfer request is logged into the first terminal; obtain payee information corresponding to the account transfer request, where the payee information includes at least identification information specifying payee contact information; determine, based on the payee information, whether the payee is a registered user of a platform that initiates the account transfer request, to obtain a first determining result; and when the first determining result indicates that the payee is not a registered user, send payment collection prompt information based on the identification information, so as to remind the payee to collect payment.

In the equipment in FIG. 5, by using the contact information as the identification information of the user, when the payee is not a registered user of the platform, the payment collection prompt information is sent to prompt the non-registered user to collect payment. In the implementation of the present specification, a registered user of the platform can transfer money to a user that is not a registered user of the platform without relying on a third-party platform, and the contact information is used as the identification information. The operation is simple, user privacy is protected, and user experience is improved.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module.

For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The logic compiler software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using the computer readable program code, logic programming can be performed on method steps to allow the controller to implement the same function in forms of the logic gate, the switch, the application-specific integrated circuit, the programmable logic controller, and the built-in microcontroller. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The system, apparatus, module, or unit illustrated in the previous implementations can be implemented by using a computer chip or an entity, or can be implemented by using a product having a certain function. A typical implementation device is a computer. The computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the apparatus above is described by dividing functions into various units. Certainly, when the present application is implemented, a function of each unit can be implemented in one or more pieces of software and/or hardware.

A person skilled in the art should understand that an implementation of the present disclosure can be provided as a method, a system, or a computer program product. Therefore, the present disclosure can use a form of hardware only implementations, software only implementations, or implementations with a combination of software and hardware. Moreover, the present disclosure can use a form of a computer program product that is implemented on one or more computer-usable storage media (including but not limited to a disk memory, a CD-ROM, an optical memory, etc.) that include computer-usable program code.

It is worthwhile to note that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate a device for implementing a specific function in one or more processes in the flowcharts and/or in one or more blocks in the block diagrams.

These computer program instructions can be stored in a computer readable memory that can instruct the computer or the another programmable data processing device to work in a specific way, so the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded onto the computer or another programmable data processing device, so a series of operations and operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), an input/output interface, a network interface, and a memory.

The memory can include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD), or another optical storage, a cassette, a cassette magnetic disk storage, or another magnetic storage device or any other non-transmission medium. The computer storage medium can be configured to store information that can be accessed by a computing device. Based on the definition in the present specification, the computer readable medium does not include transitory media such as a modulated data signal and carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

The present application can be described in the general context of computer executable instructions executed by a computer, for example, a program module. Generally, the program module includes a routine, a program, an object, a component, a data structure, etc. executing a specific task or implementing a specific abstract data type. The present application can also be practiced in distributed computing environments. In the distributed computing environments, tasks are performed by remote processing devices connected through a communications network. In a distributed computing environment, the program module can be located in both local and remote computer storage media including storage devices.

The implementations in the present specification are described in a progressive way. For same or similar parts of the implementations, references can be made to the implementations mutually. Each implementation focuses on a difference from other implementations. Particularly, a system implementation is similar to a method implementation, and therefore is described briefly. For related parts, references can be made to related descriptions in the method implementation.

The previous implementations are implementations of the present application, and are not intended to limit the present application. A person skilled in the art can make various modifications and changes to the present application. Any modification, equivalent replacement, or improvement made without departing from the spirit and principle of the present application shall fall within the scope of the claims in the present application.

1. A computer-implemented method, comprising:
obtaining, by a transfer system of a platform, an account transfer request submitted by a first terminal, wherein an initiator of the account transfer request is logged into an account of the initiator at the first terminal, the account transfer request is a request to transfer a transfer amount from the account of the initiator to a payee, and the account transfer request comprises payee information comprising identification information specifying payee contact information for the payee and a user name for the payee, the payee contact information being information by which the payee can be contacted;
obtaining, by the transfer system from the account transfer request, the payee information corresponding to the payee of the account transfer request;
creating, by the transfer system, an order corresponding to the account transfer request in an order database managed by the transfer system, the order comprising the payee contact information, the user name for the payee, and a unique order identifier for the order;
determining, by the transfer system based on the payee information, that the payee is not a registered user of the platform including querying whether the payee contact information is linked to the user name in a registered user database of the platform;
in response to determining that the payee is not a registered user of the platform, transmitting, to a second terminal of the payee, a payment prompt that is configured to prompt the payee to collect payment of the account transfer based on the identification information;
receiving, by the transfer system from a user system at which a user registered with the platform, a message indicating that the user has registered with the platform, the message comprising registration information comprising a registration user name and registration contact information for the user;
in response to receiving the message, determining, by querying the order database using the registration user name and the registration contact information of the message, that (i) the registration user name matches the user name of the order and (ii) the registration contact information matches the payee contact information of the order; and
in response to determining that (i) the registration user name matches the user name of the order and (ii) the registration contact information matches the payee contact information of the order, transferring the transfer amount to a newly created account for the user.

2. The computer-implemented method of claim 1, wherein:
the payee contact information for the payee comprises a mobile phone number of the payee and the second terminal of the payee comprises a mobile phone corresponding to the mobile phone number of the payee; and
transmitting, to the second terminal of the payee, the payment prompt comprises prompting the payee to use the mobile phone number as contact information for user registration with the platform.

3. The computer-implemented method of claim 2, wherein transmitting, to the second terminal of the payee, the payment prompt comprises:
transmitting the payment prompt to the mobile phone corresponding to the mobile phone number of the payee in a short message form; and/or
transmitting the payment prompt to the mobile phone corresponding to the mobile phone number of the payee in a voice form.

4. The computer-implemented method of claim 1, wherein:
the payee contact information for the payee comprises an email address of the payee; and
transmitting, to the second terminal of the payee, the payment prompt comprises transmitting the payment prompt to the email address of the payee, and prompting the payee to use the email address as contact information for user registration with the platform.

5. The computer-implemented method of claim 1, wherein:
before transmitting, to the second terminal of the payee, the payment prompt, the method further comprises:
determining the transfer amount in the account transfer request;
deducting the transfer amount from the account of the initiator; and
storing the transfer amount in a temporary account,
wherein transferring the transfer amount to the newly created account for the user comprises transferring the transfer amount in the temporary account to the newly created account of the user.

6. The computer-implemented method of claim 1, further comprising determining whether the registration information is consistent with the payee information, comprising:
sending the registration information to the first terminal, and prompting the initiator to confirm the registration information;
obtaining, from the first terminal, confirmation information that indicates that the initiator confirmed the registration information; and
determining, based on the confirmation information, that the registration information is consistent with the payee information.

7. The computer-implemented method of claim 1, further comprising determining whether the registration information is consistent with the payee information, comprising:
obtaining first user identity information included in the payee information, wherein the first user identity information comprises at least a name of the payee;
obtaining second user identity information included in the registration information; and
determining that the first user identity information is consistent with the second user identity information.

8. (canceled)

9. The computer-implemented method of claim 1, wherein the registration information comprises a name of the user or a name and certificate information of the user.

10. The computer-implemented method of claim 5, wherein after transmitting, to the second terminal of the payee, the payment prompt, the method further comprises:
determining whether the payee corresponding to the identification information is successfully registered within a predetermined time period; and
in response to determining that the payee corresponding to the identification information is not successfully registered within the predetermined time period, returning the transfer amount in the temporary account to the account of the initiator.

11. The computer-implemented method of claim 5, wherein after the storing the transfer amount in the temporary account, the method further comprises:
obtaining a refund request initiated by the initiator for the account transfer request; and
in response to determining that an initiating time of the refund request does not exceed a time limit, returning the transfer amount to the account of the initiator.

12. A non-transitory, computer-readable medium storing one or more instructions executable by a computer system to perform operations comprising:
obtaining, by a transfer system of a platform, an account transfer request submitted by a first terminal, wherein an initiator of the account transfer request is logged into an account of the initiator at the first terminal, the account transfer request is a request to transfer a transfer amount from the account of the initiator to a payee, and the account transfer request comprises payee information comprising identification information specifying payee contact information for the payee and a user name for the payee, the payee contact information being information by which the payee can be contacted;
obtaining, by the transfer system from the account transfer request, the payee information corresponding to the payee of the account transfer request;
creating, by the transfer system, an order corresponding to the account transfer request in an order database managed by the transfer system, the order comprising the payee contact information, the user name for the payee, and a unique order identifier for the order;
determining, by the transfer system based on the payee information, that the payee is not a registered user of the platform including querying whether the payee contact information is linked to the user name in a registered user database of the platform;
in response to determining that the payee is not a registered user of the platform, transmitting, to a second terminal of the payee, a payment prompt that is configured to prompt the payee to collect payment of the account transfer based on the identification information;
receiving, by the transfer system from a user system at which a user registered with the platform, a message indicating that the user has registered with the platform, the message comprising registration information comprising a registration user name and registration contact information for the user;
in response to receiving the message, determining, by querying the order database using the registration user name and the registration contact information of the message, that (i) the registration user name matches the user name of the order and (ii) the registration contact information matches the payee contact information of the order; and
in response to determining that (i) the registration user name matches the user name of the order and (ii) the registration contact information matches the payee contact information of the order, transferring the transfer amount to a newly created account for the user.

13. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining, by a transfer system of a platform, an account transfer request submitted by a first terminal, wherein an initiator of the account transfer request is logged into an account of the initiator at the first terminal, the account transfer request is a request to transfer a transfer amount from the account of the initiator to a payee, and the account transfer request comprises payee information comprising identification information specifying payee contact information for the payee and a user name for the payee, the payee contact information being information by which the payee can be contacted;
obtaining, by the transfer system from the account transfer request, the payee information corresponding to the payee of the account transfer request;
creating, by the transfer system, an order corresponding to the account transfer request in an order database managed by the transfer system, the order comprising the payee contact information, the user name for the payee, and a unique order identifier for the order;
determining, by the transfer system based on the payee information, that the payee is not a registered user of the platform including querying whether the payee contact information is linked to the user name in a registered user database of the platform;
in response to determining that the payee is not a registered user of the platform, transmitting, to a second terminal of the payee, a payment prompt that is configured to prompt the payee to collect payment of the account transfer based on the identification information;
receiving, by the transfer system from a user system at which a user registered with the platform, a message indicating that the user has registered with the platform, the message comprising registration information comprising a registration user name and registration contact information for the user;
in response to receiving the message, determining, by querying the order database using the registration user name and the registration contact information of the message, that (i) the registration user name matches the user name of the order and (ii) the registration contact information matches the payee contact information of the order; and
in response to determining that (i) the registration user name matches the user name of the order and (ii) the registration contact information matches the payee contact information of the order, transferring the transfer amount to a newly created account for the user.

14. The computer-implemented system of claim 13, wherein:
the payee contact information for the payee comprises a mobile phone number of the payee and the second terminal of the payee comprises a mobile phone corresponding to the mobile phone number of the payee; and
transmitting, to the second terminal of the payee, the payment prompt comprises prompting the payee to use the mobile phone number as contact information for user registration with the platform.

15. The computer-implemented system of claim 14, wherein transmitting, to the second terminal of the payee, the payment prompt comprises:
transmitting the payment prompt to the mobile phone corresponding to the mobile phone number of the payee in a short message form; and/or
transmitting the payment prompt to the mobile phone corresponding to the mobile phone number of the payee in a voice form.

16. The computer-implemented system of claim 13, wherein:
the payee contact information for the payee comprises an email address of the payee; and
transmitting, to the second terminal of the payee, the payment prompt comprises transmitting the payment prompt to the email address of the payee, and prompting the payee to use the email address as contact information for user registration with the platform.

17. The computer-implemented system of claim 13, wherein:
before transmitting, to the second terminal of the payee, the payment prompt, the operations comprise:
determining the transfer amount in the account transfer request;
deducting the transfer amount from the account of the initiator; and
storing the transfer amount in a temporary account,
wherein transferring the transfer amount to the newly created account for the user comprises transferring the transfer amount in the temporary account to the newly created account of the payee user, wherein contact information of the newly created account of the user.

18. The computer-implemented system of claim 13, wherein the operations comprise determining whether the registration information is consistent with the payee information, comprising:
sending the registration information to the first terminal, and prompting the initiator to confirm the registration information;
obtaining, from the first terminal, confirmation information that indicates that the initiator confirmed the registration information; and
determining, based on the confirmation information, that the registration information is consistent with the payee information.

19. The computer-implemented system of claim 13, wherein the operations comprise determining whether the registration information is consistent with the payee information, comprising:
obtaining first user identity information included in the payee information, wherein the first user identity information comprises at least a name of the payee;
obtaining second user identity information included in the registration information; and
determining that the first user identity information is consistent with the second user identity information.

20. (canceled)
